(19) United States
(12) Patent Application Publication
(10) Pub. No.: US 2017/0349791 A1
(43) Pub. Date: Dec. 7, 2017

(54) ADHESIVE COMPOSITION, ADHESIVE FILM FORMED FROM SAME, AND DISPLAY MEMBER COMPRISING SAME

(71) Applicants: SAMSUNG SDI CO., LTD., Yongin-si, Gyeonggi-do (KR); SAMSUNG ELECTRONICS CO., LTD., Suwon-si, Gyeonggi-do (KR)

(72) Inventors: Gwang Hwan LEE, Uiwang-si (KR); Byeong Do KWAK, Uiwang-si (KR); Il Jin KIM, Uiwang-si (KR); Ji Ho KIM, Uiwang-si (KR); Hyung Rang MOON, Uiwang-si (KR); Sung Hyun MOON, Uiwang-si (KR); Jae Hyun HAN, Uiwang-si (KR)

(21) Appl. No.: 15/539,104

(22) PCT Filed: Dec. 2, 2015
(86) PCT No.: PCT/KR2015/013049

§ 371 Date: Jun. 22, 2017

(30) Foreign Application Priority Data
Dec. 23, 2014 (KR) 10-2014-0187619

(51) Int. Cl. C09J 11/06; C09J 133/06; C09J 7/00

(52) U.S. Cl. CPC C09J 11/06; C09J 7/00; C09J 133/06

(57) ABSTRACT

Disclosed herein is an adhesive film which includes: a monomer mixture including a hydroxyl group-containing (meth)acrylate and a comonomer; and nanoparticles, wherein the nanoparticles include a silicone polymer and have an average particle diameter of about 5 nm to about 800 nm.

### CROSS-REFERENCE TO RELATED APPLICATIONS

This Application is a National Phase Patent Application and claims priority to and the benefit of International Application Number PCT/KR2015/013049, filed on Dec. 2, 2015, which claims priority to and the benefit of Korean Application No. 10-2014-0187619, filed on Dec. 23, 2014, the entire contents of each of which are incorporated herein by reference.

### BACKGROUND

### 1. Field

The present invention relates to an adhesive composition, an adhesive film formed from the same, and a display member including the same.

### 2. Description of the Related Art

A transparent adhesive film is used as an adhesive film in interlayer bonding for stacking parts in an optical display or in attachment of a touchscreen of a mobile phone.

In particular, a capacitive touch pad among optical displays is attached to a window or film via an adhesive film and has properties thereof by sensing a change in capacitance of the window or film. An adhesive film in touch pads is stacked between a window glass and a TSP sensor glass.

The transparent adhesive film has a merit of improving clarity of a screen as compared with existing double-sided tapes and exhibiting good adhesion while acting like glass by transmitting 97% or more of light. The transparent adhesive film can be used for tablet PCs, TVs and the like including a middle or large-sized display screen as well as for mobile phones.

Recently, along with severer environments of using, storing and/or manufacturing optical displays and an increasing interest in flexible optical displays and the like, various properties are required for the transparent adhesive film. In particular, for application to flexible displays, there is a need for a transparent adhesive film which maintains viscoelasticity in a wide temperature range and also exhibits excellent recoverability.

One example of the related art is disclosed in Korean Patent Publication No. 2007-0055363A.

### SUMMARY

It is one aspect of the present invention to provide an adhesive composition which has excellent adhesion and excellent viscoelasticity in a wide temperature range, an adhesive film formed from the same, and a display member.

It is another aspect of the present invention to provide an adhesive composition which has excellent transparency and reliability in severer environments, an adhesive film formed from the same, and a display member.

In accordance with one aspect of the present invention, an adhesive composition includes: a monomer mixture including a hydroxyl group-containing (meth)acrylate and a comonomer; and nanoparticles, wherein the nanoparticles include a silicone polymer and have an average particle diameter of about 5 nm to about 800 nm.

In accordance with another aspect of the present invention, an adhesive film may be formed of the adhesive composition as set forth above.

In accordance with a further aspect of the present invention, a display member may include an optical film and the adhesive film as set forth above on one or both surfaces of the optical film.

The present invention has effects to provide an adhesive composition, which exhibits excellent adhesion, recoverability, transparency and reliability while maintaining viscoelasticity in a wide temperature range, an adhesive film formed of the adhesive composition, and a display member including the adhesive film.

### BRIEF DESCRIPTION OF THE DRAWINGS

FIG. 1 is a sectional view of a display member according to one embodiment of the present invention.

FIG. 2 is a conceptual diagram of a specimen for measuring T-peel strength.

FIG. 3 shows sectional and plan views of a specimen for measuring recovery rate.

### DETAILED DESCRIPTION

As used herein, the term “(meth)acrylate” may refer to acrylates and/or methacrylates.

As used herein, the term “copolymer” may include oligomers, polymers, or resins.

As used herein, the term “comonomer” refers to a monomer polymerized with a hydroxyl group-containing (meth)acrylate, and may be any monomer without limitation so long as the monomer can be polymerized with a hydroxyl group-containing (meth)acrylate.

As used herein, the term “(meth)acrylic copolymer” may refer to copolymers of an acrylic monomer and nanoparticles.

As used herein, the term “glass transition temperature” of a monomer may refer to a glass transition temperature measured on a homopolymer of a measurement target monomer using DSC Discovery (TA Instrument Inc.). Specifically, a homopolymer of a measurement target monomer is heated to about 100° C. at a rate of about 20° C./min, followed by cooling the homopolymer to about −180° C. at the same rate as the heating rate, and then heated to about 100° C. at a rate of about 10° C./min, thereby obtaining data of an endothermic transition curve. An inflection point of the endothermic transition curve is determined as the glass transition temperature.

As used herein, the term “average particle diameter” refers to a z-average particle diameter of nanoparticles, as measured in a water-based or organic solvent using Zetasizer nano-ZS (Malvern Co., Ltd.).

As used herein, the term “core-shell structure” may refer to typical core-shell structures including structures having several layers of cores or shells, and the term “outermost layer” refers to the outermost layer among the several layers. In addition, the term “core-shell particles” used herein refers to nanoparticles having a core-shell structure.

As used herein, the term “T-peel strength with respect to a corona-treated polyethylene terephthalate (PET) film” refers to a value measured by the following procedures i) to v).

i) An adhesive composition is coated onto a polyethylene terephthalate (PET) release film, followed by UV irradiation at a dose of about 2000 mJ/cm², thereby manufacturing an about 100 μm thick adhesive sheet of an adhesive film and the PET film.

ii) A PET film, which has a size of about 150 mm×about 25 mm×about 75 μm (length×width×thickness) and is subjected to corona treatment about twice (total dose: about 156) under corona discharge at a dose of about 78 using a corona treatment device, is prepared.

iii) An adhesive film sample having a size of about 100 mm×about 25 mm×about 100 μm (length×width×thickness) is obtained from the adhesive sheet, followed by laminating the corona-treated surfaces of the PET films to both surfaces of the adhesive film sample, thereby preparing a specimen, as shown in FIG. 2(a).

iv) The specimen is autoclaved under conditions of about 3.5 bar and about 50° C. for about 1,000 seconds and secured to a TA.XT_Plus texture analyzer (Stable Micro Systems Co., Ltd.).

v) In the TA.XT_Plus texture analyzer, the PET film at one side is kept fixed and the PET film at the other side is pulled at a rate of about 50 mm/min, thereby measuring T-peel strength (see FIG. 2(b)).

As used herein, the term “T-peel strength with respect to a non-corona-treated polyethylene terephthalate (PET) film (hereinafter referred to as a non-corona PET)” refers to a value measured in the same manner as in the method of measuring T-peel strength with respect to a corona-treated polyethylene terephthalate (PET) film except that the procedure ii) of performing corona treatment of the PET film is omitted.

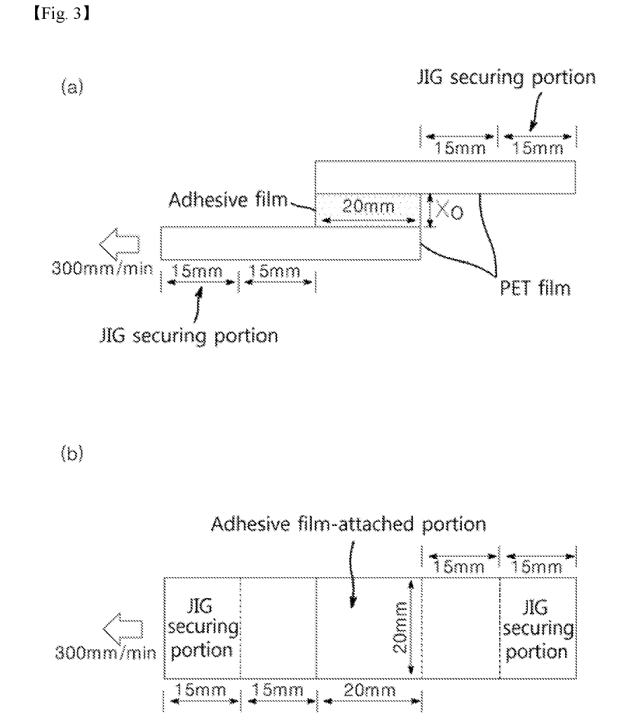

Herein, the “recovery rate” can be measured through the following procedures: When both ends of each polyethylene terephthalate (PET) film (thickness: about 75 μm) having a size of about 50 mm×about 20 mm (length×width) are defined as a first end and a second end, respectively, a specimen is prepared by bonding ends of two PET films to each other via an adhesive film having a size of about 20 mm×about 20 mm (length×width) in order of first end of first PET film/adhesive film/second end of second PET film, and has a contact area of about 20 mm×about 20 mm (length×width) between each of the PET films and the adhesive film (see FIGS. 3(a) and 3(b)). Referring to FIG. 3(a), jigs are secured to non-bonded ends of the PET films of the specimen at room temperature (about 25° C.), respectively. Next, the jig at one side is kept fixed, and the jig at the other side is pulled to a length of about 1,000% of thickness (unit: μm) of the adhesive film (to a length of about 10 times an initial thickness (X₀) of the adhesive film) at a rate of about 300 mm/min and then maintained for about 10 seconds. Next, when an increased length of the adhesive film is defined as X_{f} (unit: μm) when a force of about 0 kPa is applied to the adhesive film by recovering the adhesive film at the same rate (about 300 mm/min) as the pulling rate, the recovery rate (%) is calculated by Equation 2.

Recovery rate (%)=(1−(X_{f}/X₀))?100 [Equation 2]

Here, the initial thickness of the adhesive film may range from 20 μm to 300 μm. Recovery rate may be measured using a TA.XT_Plus texture analyzer (Stable Micro Systems Co., Ltd.). Recovery rate may be measured at 25° C.

As used herein, the term “elongation” refers to a ratio (%) of length of an adhesive film at break to length of the adhesive film before stretching (100%), in which the length of the adhesive film at break is measured by stretching the adhesive film at a rate of about 300 mm/min until the adhesive film breaks, after cutting the adhesive film to a size of about 5 cm×about 5 cm×about 100 μm, followed by tightly rolling up the adhesive film and securing both ends of the adhesive film to a TA.XT_Plus texture analyzer (Stable Micro Systems Co., Ltd.).

As used herein, the term “bubble generation area” refers to a value (%) measured through the following procedures: An adhesive film (length×width×thickness: about 13 cm×about 3 cm×about 100 μm) including a about 50 μm thick PET film stacked on one surface thereof and a about 100 μm thick PET film stacked on the other surface thereof is bent towards the about 50 μm thick PET film such that the length of the adhesive film is halved, and is then placed between parallel frames having a gap of about 1 cm. Next, the adhesive film is subjected to aging at about 70° C. and about 93% RH for about 24 hours, followed by analyzing an image, which is obtained through observation of portions of the adhesive film suffering from bubbles using an optical microscope (EX-51, Olympus Co., Ltd., magnification: 30×), using Mac-View software (Mountech Co., Ltd.) to measure a ratio of area occupied by bubbles to area of the adhesive film.

### Adhesive Composition

One aspect of the present invention relates to an adhesive composition. The adhesive composition includes: a monomer mixture including a hydroxyl group-containing (meth)acrylate and a comonomer; and nanoparticles, wherein the nanoparticles include a silicone polymer and have an average particle diameter of about 5 nm to about about 800 nm.

### Monomer Mixture

The monomer mixture includes the hydroxyl group-containing (meth)acrylate and the comonomer. The monomer mixture may be polymerized to form a hydroxyl group-containing (meth)acrylic copolymer.

The hydroxyl group-containing (meth)acrylate may be a C₁ to C₂₀ alkyl group-containing (meth)acrylic acid ester having at least one hydroxyl group, a C₅ to C₂₀ cycloalkyl group-containing (meth)acrylic acid ester having at least one hydroxyl group, or a C₆ to C₂₀ aryl group-containing (meth)acrylic acid ester having at least one hydroxyl group.

For example, the hydroxyl group-containing (meth)acrylate may include at least one of 2-hydroxyethyl (meth)acrylate, 4-hydroxybutyl (meth)acrylate, 2-hydroxypropyl (meth)acrylate, 2-hydroxybutyl (meth)acrylate, and 6-hydroxyhexyl (meth)acrylate, without being limited thereto. In particular, the hydroxyl group-containing (meth)acrylate may be a C₁ to C₅ alkyl group-containing (meth)acrylic monomer having a hydroxyl group, whereby the adhesive film can have further improved adhesion.

In one embodiment, the hydroxyl group-containing (meth)acrylate may be a hydroxyl group-containing (meth)acrylate having a glass transition temperature (Tg) of about −80° C. to about −20° C., specifically about −60° C. to about −35° C. For example, the hydroxyl group-containing (meth)acrylate may be 4-hydroxybutyl (meth)acrylate, without being limited thereto. Within this temperature range, the adhesive film can exhibit excellent viscoelasticity at low temperature and/or room temperature.

The hydroxyl group-containing (meth)acrylate may be present in an amount of about 15% by weight (wt %) to about about 45 wt %, specifically about 25 wt % to about about 40 wt % in the monomer mixture. Within this range, the adhesive film has low haze and excellent adhesion.

The comonomer may include at least one of alkyl (meth)acrylate monomers, ethylene oxide-containing monomers, propylene oxide-containing monomers, amine group-containing monomers, amide group-containing monomers, alkoxy group-containing monomers, phosphoric acid group-containing monomers, sulfonic acid group-containing monomers, phenyl group-containing monomers, and silane group-containing monomers, without being limited thereto.

The alkyl (meth)acrylate monomer may include unsubstituted C₁ to C₂₀ linear or branched alkyl (meth)acrylic acid esters. For example, the alkyl (meth)acrylate monomer may include at least one of methyl (meth)acrylate, ethyl (meth)acrylate, propyl (meth)acrylate, n-butyl (meth)acrylate, t-butyl (meth)acrylate, iso-butyl (meth)acrylate, pentyl (meth)acrylate, hexyl (meth)acrylate, 2-ethylhexyl (meth)acrylate, heptyl (meth)acrylate, ethylhexyl (meth)acrylate, octyl (meth)acrylate, isooctyl (meth)acrylate, nonyl (meth)acrylate, decyl (meth)acrylate, and lauryl (meth)acrylate. Specifically, the alkyl (meth)acrylate monomer may be a C₄ to C₈ alkyl (meth)acrylic monomer, whereby the adhesive composition can have further improved initial adhesion.

The ethylene oxide-containing monomer may include at least one ethylene oxide group (—CH₂CH₂O—)-containing (meth)acrylate monomer. For example, the ethylene oxide-containing monomer may include polyethylene oxide alkyl ether (meth)acrylates such as polyethylene oxide monomethyl ether (meth)acrylate, polyethylene oxide monoethyl ether (meth)acrylate, polyethylene oxide monopropyl ether (meth)acrylate, polyethylene oxide monobutyl ether (meth)acrylate, polyethylene oxide monopentyl ether (meth)acrylate, polyethylene oxide dimethyl ether (meth)acrylate, polyethylene oxide diethyl ether (meth)acrylate, polyethylene oxide monoisopropyl ether (meth)acrylate, polyethylene oxide monoisobutyl ether (meth)acrylate, and polyethylene oxide mono-tert-butyl ether (meth)acrylate, without being limited thereto.

The propylene oxide-containing monomer may include polypropylene oxide alkyl ether (meth)acrylates such as polypropylene oxide monomethyl ether (meth)acrylate, polypropylene oxide monoethyl ether (meth)acrylate, polypropylene oxide monopropyl ether (meth)acrylate, polypropylene oxide monobutyl ether (meth)acrylate, polypropylene oxide monopentyl ether (meth)acrylate, polypropylene oxide dimethyl ether (meth)acrylate, polypropylene oxide diethyl ether (meth)acrylate, polypropylene oxide monoisopropyl ether (meth)acrylate, polypropylene oxide monoisobutyl ether (meth)acrylate, and polypropylene oxide mono-tert-butyl ether (meth)acrylate, without being limited thereto.

The amino group-containing monomer may include amino group-containing (meth)acrylic monomers such as monomethylaminoethyl (meth)acrylate, monoethylaminoethyl (meth)acrylate, monomethylaminopropyl (meth)acrylate, monoethylaminopropyl (meth)acrylate, dimethylaminoethyl (meth)acrylate, diethylaminoethyl (meth)acrylate, N-tert-butylaminoethyl (meth)acrylate, and methacryloxyethyltrimethyl ammonium chloride (meth)acrylate, without being limited thereto.

The amide group-containing monomer may include amide group-containing (meth)acrylic monomers such as (meth)acrylamide, N-methyl acrylamide, N-methyl methacrylamide, N-methylol (meth)acrylamide, N-methoxymethyl (meth)acrylamide, N,N-methylene bis(meth)acrylamide, and 2-hydroxyethyl acrylamide, without being limited thereto.

The alkoxy group-containing monomer may include 2-methoxyethyl (meth)acrylate, 2-methoxypropyl (meth)acrylate, 2-ethoxypropyl (meth)acrylate, 2-butoxypropyl (meth)acrylate, 2-methoxypentyl (meth)acrylate, 2-ethoxypentyl (meth)acrylate, 2-butoxyhexyl (meth)acrylate, 3-methoxypentyl (meth)acrylate, 3-ethoxypentyl (meth)acrylate, and 3-butoxyhexyl (meth)acrylate, without being limited thereto.

The phosphoric acid group-containing monomer may include phosphoric acid group-containing acrylic monomers such as 2-methacryloyloxyethyldiphenylphosphate (meth)acrylate, trimethacryloyloxyethylphosphate (meth)acrylate, and triacryloyloxyethylphosphate (meth)acrylate, without being limited thereto.

The sulfonic acid group-containing monomer may include sulfonic acid group-containing acrylic monomers such as sodium sulfopropyl (meth)acrylate, sodium 2-sulfoethyl (meth)acrylate, and sodium 2-acrylamido-2-methylpropane sulfonate, without being limited thereto.

The phenyl group-containing monomer may include phenyl group-containing acrylic vinyl monomers such as p-tert-butylphenyl (meth)acrylate and o-biphenyl (meth)acrylate, without being limited thereto.

The silane group-containing monomer may include silane group-containing vinyl monomers such as 2-acetoacetoxyethyl (meth)acrylate, vinyltrimethoxysilane, vinyltriethoxysilane, vinyl tris(β-methoxyethyl)silane, vinyltriacetylsilane, and methacryloyloxypropyltrimethoxysilane, without being limited thereto.

The comonomer may be present in an amount of about 55 wt % to about about 85 wt %, specifically about 60 wt % to about 75 wt % in the monomer mixture. Within this range, the adhesive film exhibits excellent adhesion and reliability.

In another embodiment, the comonomer may have a glass transition temperature (Tg) of about −150° C. to about 0° C. Here, the glass transition temperature may be measured, for example, on a homopolymer of each measurement target monomer using Discovery Q20 calorimeter (TA Instrument Inc.). Specifically, a homopolymer of each monomer is heated to about 100° C. at a rate of about 20° C./min, followed by cooling the homopolymer to about −180° C. at the same rate as the heating rate, and then heated to about 100° C. at a rate of about 10° C./min, thereby obtaining data of an endothermic transition curve. An inflection point of the endothermic transition curve is determined as the glass transition temperature. The comonomer having a glass transition temperature (Tg) of about −150° C. to about 0° C. may be any comonomer without limitation so long as the comonomer has a glass transition temperature (Tg) of about −150° C. to about 0° C. Specifically, the comonomer may be a monomer having a glass transition temperature (Tg) of about −150° C. to about −20° C., more specifically a monomer having a glass transition temperature (Tg) of about −150° C. to about −40° C.

In a further embodiment, the comonomer may include at least one of alkyl (meth)acrylate monomers, ethylene oxide-containing monomers, propylene oxide-containing monomers, amine group-containing monomers, amide group-containing monomers, alkoxy group-containing monomers, phosphoric acid group-containing monomers, sulfonic acid group-containing monomers, phenyl group-containing monomers, and silane group-containing monomers, which have a glass transition temperature (Tg) of about −150° C. to about 0° C.

For example, the comonomer may include at least one of alkyl (meth)acrylate monomers including methyl acrylate, ethyl acrylate, isopropyl acrylate, n-butyl acrylate, iso-butyl acrylate, hexyl (meth)acrylate, heptyl (meth)acrylate, 2-ethylhexyl acrylate, dodecyl (meth)acrylate, and the like; alkylene oxide group-containing (meth)acrylate monomers including polyethylene oxide monomethyl ether (meth)acrylate, polyethylene oxide monoethyl ether (meth)acrylate, polyethylene oxide monopropyl ether (meth)acrylate, polyethylene oxide monobutyl ether (meth)acrylate, polyethylene oxide monopentyl ether (meth)acrylate, polypropylene oxide monomethyl ether (meth)acrylate, polypropylene oxide monoethyl ether (meth)acrylate, polypropylene oxide monopropyl ether (meth)acrylate, and the like; amino group-containing (meth)acrylate monomers including monomethylaminoethyl (meth)acrylate, monoethylaminoethyl (meth)acrylate, monomethylaminopropyl (meth)acrylate, monoethylaminopropyl (meth)acrylate, and the like; alkoxy group-containing (meth)acrylate monomers including 2-methoxyethyl (meth)acrylate, 2-methoxypropyl (meth)acrylate, 2-ethoxypropyl (meth)acrylate and the like; and silane group-containing (meth)acrylate monomers including 2-acetoacetoxyethyl (meth)acrylate, vinyltrimethoxysilane, vinyltriethoxysilane, and the like.

In one embodiment, the monomer mixture forming the hydroxyl group-containing (meth)acrylic copolymer may further include a carboxyl group-containing monomer.

The carboxyl group-containing monomer may include (meth)acrylic acid, 2-carboxyethyl (meth)acrylate, 3-carboxypropyl (meth)acrylate, 4-carboxybutyl (meth)acrylate, itaconic acid, crotonic acid, maleic acid, fumaric acid, and maleic anhydride, without being limited thereto.

The carboxyl group-containing monomer may be present in an amount of about 0.1 wt % to about 10 wt %, specifically about 0.1 wt % to about 7 wt %, more specifically about 0.1 wt % to about 5 wt % in the monomer mixture. Within this range, the adhesive film exhibits excellent adhesion and reliability.

### Nanoparticles

The adhesive composition includes the nanoparticles, whereby the adhesive film exhibits excellent low temperature and/or room temperature viscoelasticity and has stable high temperature viscoelasticity due to a crosslinked structure thereof. In one embodiment, the nanoparticles may form a chemical bond to the hydroxyl group-containing (meth)acrylic copolymer.

Specifically, the nanoparticles, which have a specific average particle diameter and a small difference in index of refraction from the hydroxyl group-containing (meth)acrylic copolymer, are used, whereby the adhesive film can exhibit excellent transparency can be obtained while including the nanoparticles.

The nanoparticles may have an average particle diameter of about 5 nm, 10 nm, 15 nm, 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm, 100 nm, 110 nm, 120 nm, 130 nm, 140 nm, 150 nm, 160 nm, 170 nm, 180 nm, 190 nm, 200 nm, 210 nm, 220 nm, 230 nm, 240 nm, 250 nm, 260 nm, 270 nm, 280 nm, 290 nm, 300 nm, 310 nm, 320 nm, 330 nm, 340 nm, 350 nm, 360 nm, 370 nm, 380 nm, 390 nm, 400 nm, 410 nm, 420 nm, 430 nm, 440 nm, 450 nm, 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, 650 nm, 660 nm, 670 nm, 680 nm, 690 nm, 700 nm, 710 nm, 720 nm, 730 nm, 740 nm, 750 nm, 760 nm, 770 nm, 780 nm, 790 nm, or 800 nm. In addition, the nanoparticles may have an average particle diameter ranging from about one of the numerical values set forth above to about another one of the numerical values set forth above. For example, the nanoparticles may have an average particle diameter of about 5 nm to about 800 nm, specifically about 5 nm to about 700 nm, more specifically about 10 nm to about 400 nm. Within this range, agglomeration of the nanoparticles can be prevented and the adhesive film exhibits excellent transparency.

A difference in index of refraction between the nanoparticles and the hydroxyl group-containing (meth)acrylic copolymer formed of the monomer mixture may be about 0.05 or less, and may specifically range from about 0 to about 0.05, more specifically from about 0 to about 0.03, still more specifically from about 0 to about 0.02. Within this range, the adhesive film exhibits excellent transparency.

The nanoparticles may have a core-shell structure, and the core and the shell may have a glass transition temperature satisfying Equation 1:

Tg(c)<Tg(s) [Equation 1]

(where Tg (c) is a glass transition temperature (° C.) of the core and Tg (s) is a glass transition temperature (° C.) of the shell).

The core may have a glass transition temperature of about −200° C. to about −40° C., specifically about −200° C. to about −80° C., more specifically about −200° C. to about −90° C. Within this range, the adhesive film can realize storage modulus required at low temperature (about −20° C.) and exhibits excellent low temperature and/or room temperature viscoelasticity.

The nanoparticles may include a silicone polymer, and the silicone polymer may have the core-shell structure as set forth above.

The core of the silicone polymer may be a polysiloxane or mixtures thereof having the glass transition temperature of the core of the nanoparticles as set forth above. For example, the polysiloxane may be an organosiloxane (co)polymer. The organosiloxane (co)polymer may be a non-crosslinked or crosslinked organosiloxane (co)polymer. The organosiloxane (co)polymer may be a crosslinked organosiloxane (co)polymer for impact resistance and pigmenting properties. Specifically, the crosslinked organosiloxane (co)polymer may include crosslinked dimethylsiloxane, methylphenylsiloxane, diphenylsiloxane, and mixtures thereof. In the organosiloxane (co)polymer, two or more organosiloxanes are copolymerized, whereby the nanoparticles can be adjusted to an index of refraction of about 1.41 to about 1.50.

A crosslinked state of the organosiloxane (co)polymer may be determined depending upon a degree of dissolution in various organic solvents. As the crosslinked state of the organosiloxane (co)polymer is intensified, the degree of dissolution thereof becomes lower. A solvent for determining a crosslinked state may include acetone, toluene, and the like. Specifically, the organosiloxane (co)polymer may have a moiety which is not dissolved in acetone or toluene. The organosiloxane copolymer may include about 30% or more of insolubles in toluene.

In addition, the organosiloxane (co)polymer may further include an alkyl acrylate crosslinked polymer. The alkyl acrylate crosslinked polymer may include methyl acrylate, ethyl acrylate, n-butyl acrylate, 2-ethylhexyl acrylate, and the like. For example, the alkyl acrylate crosslinked polymer may be n-butyl acrylate or 2-ethylhexyl acrylate having a low glass transition temperature.

The shell of the silicone polymer may have a glass transition temperature of about 15° C. to about 200° C., specifically about 15° C. to about 180° C., more specifically about 15° C. to about 150° C. Within this range, the nanoparticles have good processability.

The shell may include poly(meth)acrylates having the glass transition temperature as set forth above. For example, the shell may include at least one of polymethyl acrylate, polymethylmethacrylate (PMMA), polyethyl methacrylate, polypropyl methacrylate, polybutyl methacrylate, polyisopropyl methacrylate, polyisobutyl methacrylate, polycyclohexyl methacrylate, polyphenyl methacrylate, and polybenzyl methacrylate, without being limited thereto. Specifically, the shell may include polymethylmethacrylate.

In some embodiments, the shell may include two or more layers. In these embodiments, an outermost layer of the nanoparticles may include polyalkyl (meth)acrylates having a glass transition temperature (Tg) of about 15° C. to about 200° C.

In one embodiment, the nanoparticles included in the adhesive composition may be used in a state of being polymerized with the monomer mixture in preparation of the hydroxyl group-containing (meth)acrylic copolymer. In this case, the nanoparticles may be used in a state of being included in the hydroxyl group-containing (meth)acrylic copolymer.

In another embodiment, the adhesive composition may include the prepared hydroxyl group-containing (meth)acrylic copolymer and the nanoparticles. In this case, the nanoparticles may be included in the adhesive composition separately from the hydroxyl group-containing (meth)acrylic copolymer.

The nanoparticles may be present in an amount of about 0.1 parts by weight, 0.2 parts by weight, 0.3 parts by weight, 0.4 parts by weight, 0.5 parts by weight, 0.6 parts by weight, 0.7 parts by weight, 0.8 parts by weight, 0.9 parts by weight, 1 part by weight, 1.5 parts by weight, 2 parts by weight, 2.5 parts by weight, 3 parts by weight, 3.5 parts by weight, 4 parts by weight, 4.5 parts by weight, 5 parts by weight, 5.5 parts by weight, 6 parts by weight, 6.5 parts by weight, 7 parts by weight, 7.5 parts by weight, 8 parts by weight, 8.5 parts by weight, 9 parts by weight, 9.5 parts by weight, 10 parts by weight, 10.5 parts by weight, 11 parts by weight, 11.5 parts by weight, 12 parts by weight, 12.5 parts by weight, 13 parts by weight, 13.5 parts by weight, 14 parts by weight, 14.5 parts by weight, 15 parts by weight, 15.5 parts by weight, 16 parts by weight, 16.5 parts by weight, 17 parts by weight, 17.5 parts by weight, 18 parts by weight, 18.5 parts by weight, 19 parts by weight, 19.5 parts by weight, or 20 parts by weight based on 100 parts by weight of the monomer mixture including the hydroxyl group-containing (meth)acrylate and the comonomer. In addition, the nanoparticles may be present in an amount ranging from about one of the numerical values set forth above to about another one of the numerical values set forth above based on 100 parts by weight of the monomer mixture forming the hydroxyl group-containing (meth)acrylic copolymer. For example, the nanoparticles may be present in an amount of about 0.1 parts by weight to about 20 parts by weight, specifically about 0.1 parts by weight to about 18 parts by weight, more specifically about 0.1 parts by weight to about 15 parts by weight. Within this range, the adhesive film can have balance between viscoelasticity, storage modulus and recovery rate.

A weight ratio of the core to the shell of the nanoparticles may range from about 1:1 to about 9:1, specifically about 1:1 to about 8:1, more specifically about 1.5:1 to about 8:1. Within this range, viscoelasticity of an adhesive film can be maintained in a wide temperature range, and the adhesive film can has excellent compatibility and recovery rate.

The adhesive composition may further include at least one of an initiator and a crosslinking agent.

### Initiator

The initiator may include a photopolymerization initiator and a thermal polymerization initiator. The initiator may be an initiator which is the same as or different from the initiator used in the preparation of a partially polymerized prepolymer.

The photopolymerization initiator may be any initiator so long as the initiator can realize a second crosslinking structure by deriving polymerization of the radical polymerizable compound during curing through light irradiation. For example, the photopolymerization initiator may include benzoin, hydroxyl ketone, amino ketone, phosphine oxide photoinitiators, and the like. Specifically, the photopolymerization initiator may include benzoin, benzoin methyl ether, benzoin ethyl ether, benzoin isopropyl ether, benzoin n-butyl ether, benzoin isobutyl ether, acetophenone, dimethylamino acetophenone, 2,2-dimethoxy-2-phenylacetophenone, 2,2-diethoxy-2-phenylacetophenone, 2-hydroxy-2-methyl-1-phenylpropan-1-one, 1-hydroxycyclohexyl phenyl ketone, 2-methyl-1-[4-(methylthio)phenyl]-2-morpholino-propan-1-one, 4-(2-hydroxyethoxy)phenyl-2-(hydroxy-2-propyl)ketone, benzophenone, p-phenylbenzophenone, 4,4′-bis(diethyl)aminobenzophenone, dichlorobenzophenone, 2-methylanthraquinone, 2-ethylanthraquinone, 2-t-butylanthraquinone, 2-aminoanthraquinone, 2-methylthioxanthone, 2-ethylthioxanthone, 2-chlorothioxanthone, 2,4-dimethylthioxanthone, 2,4-diethylthioxanthone, benzyl dimethyl ketal, acetophenone dimethyl ketal, p-dimethylaminobenzoic acid ester, oligo[2-hydroxy-2-methyl-1-[4-(1-methylvinyl)phenyl]propanone], and 2,4,6-trimethylbenzoyl-diphenyl-phosphine oxide, without being limited thereto. These photopolymerization initiators may be used alone or in combination thereof.

The thermal polymerization initiator may be any initiator without limitation so long as the initiator can realize a second crosslinking structure by deriving polymerization of a polymerizable compound. For example, the thermal polymerization initiator may include typical initiators such as azo, peroxide and redox compounds. Examples of the azo compound may include 2,2-azobis(2-methylbutyronitrile), 2,2-azobis(isobutyronitrile), 2,2-azobis(2,4-dimethylvaleronitrile), 2,2-azobis-2-hydroxymethylpropionitrile, dimethyl-2,2-methylazobis(2-methylpropionate), and 2,2-azobis(4-methoxy-2,4-dimethylvaleronitrile), without being limited thereto. Examples of the peroxide compound may include: inorganic peroxides such as potassium perchlorate, ammonium persulfate and hydrogen peroxide; and organic peroxides such as diacyl peroxide, peroxydicarbonate, peroxyester, tetramethylbutyl peroxyneodecanoate, bis(4-butylcyclohexyl) peroxydicarbonate, di(2-ethylhexyl) peroxycarbonate, butyl peroxyneodecanoate, dipropyl peroxydicarbonate, diisopropyl peroxydicarbonate, diethoxyethyl peroxydicarbonate, diethoxyhexyl peroxydicarbonate, hexyl peroxydicarbonate, dimethoxybutyl peroxydicarbonate, bis(3-methoxy-3-methoxybutyl) peroxydicarbonate, dibutyl peroxydicarbonate, dicetyl peroxydicarbonate, dimyristyl peroxydicarbonate, 1,1,3,3-tetramethylbutyl peroxypivalate, hexyl peroxypivalate, butyl peroxypivalate, trimethylhexanoyl peroxide, dimethyl hydroxybutyl peroxyneodecanoate, amyl peroxyneodecanoate, t-butyl peroxy neoheptanoate, amyl peroxypivalate, t-butyl peroxypivalate, t-amyl peroxy-2-ethylhexanoate, lauroyl peroxide, dilauroyl peroxide, di(dodecanoyl) peroxide, benzoyl peroxide, and dibenzoyl peroxide, without being limited thereto. Examples of the redox compound may include mixtures of a peroxide compound and a reductant, without being limited thereto. These azo, peroxide and redox compounds may be used alone or in combination thereof.

The initiator may be present in an amount of about 0.01 parts by weight to about 5 parts by weight, specifically about 0.05 parts by weight to about 3 parts by weight, more specifically about 0.1 parts by weight to about 1 part by weight based on 100 parts by weight of the monomer mixture. Within this range, curing can be completely performed, deterioration in transmittance of the adhesive film due to the residual initiator can be prevented, bubble generation can be prevented, and the adhesive composition can have excellent reactivity.

### Crosslinking Agent

The crosslinking agent may be a polyfunctional (meth)acrylate. Examples of the polyfunctional (meth)acrylate may include: bifunctional acrylates such as 1,4-butanediol di(meth)acrylate, 1,6-hexanediol di(meth)acrylate, neopentylglycol di(meth)acrylate, polyethylene glycol di(meth)acrylate, neopentylglycol adipate di(meth)acrylate, dicyclopentanyl di(meth)acrylate, caprolactone-modified dicyclopentenyl di(meth)acrylate, ethylene oxide-modified di(meth)acrylate, di(meth)acryloxyethyl isocyanurate, allylated cyclohexyl di(meth)acrylate, tricyclodecane dimethanol di(meth)acrylate, dimethylol dicyclopentane di(meth)acrylate, ethylene oxide-modified hexahydrophthalic acid di(meth)acrylate, neopentylglycol-modified trimethylpropane di(meth)acrylate, adamantane di(meth)acrylate, 9,9-bis[4-(2-acryloyloxyethoxy)phenyl] fluorine and the like; trifunctional acrylates such as trimethylolpropane tri(meth)acrylate, dipentaerythritol tri(meth)acrylate, propionic acid-modified dipentaerythritol tri(meth)acrylate, pentaerythritol tri(meth)acrylate, propylene oxide-modified trimethylolpropane tri(meth)acrylate, trifunctional urethane (meth)acrylates, tris(meth)acryloxyethylisocyanurate and the like; tetrafunctional acrylates such as diglycerin tetra(meth)acrylate, pentaerythritol tetra(meth)acrylate and the like; pentafunctional acrylates such as dipentaerythritol penta(meth)acrylate and the like; hexafunctional acrylates such as dipentaerythritol hexa(meth)acrylate, caprolactone-modified dipentaerythritol hexa(meth)acrylate, and urethane (meth)acrylates (for example, reaction products of an isocyanate monomer and trimethylolpropane tri(meth)acrylate), without being limited thereto. These crosslinking agents may be used alone or in combination thereof. Specifically, the crosslinking agent may be a polyfunctional (meth)acrylate of a polyhydric alcohol containing 2 to 20 hydroxyl groups to provide excellent durability to an adhesive film.

The crosslinking agent may be present in an amount of about 0.01 parts by weight to about 5 parts by weight, specifically about 0.03 parts by weight to about 3 parts by weight, more specifically about 0.1 parts by weight to about 0.3 parts by weight based on 100 parts by weight of the monomer mixture. Within this range, the adhesive film exhibits improved adhesion and reliability.

In another embodiment, the adhesive composition may further include a silane coupling agent.

### Silane Coupling Agent

The silane coupling agent may include siloxane and epoxy silane coupling agents, without being limited thereto. The silane coupling agent may be present in an amount of about 0.01 parts by weight to about 5 parts by weight, specifically about 0.01 parts by weight to about 2 parts by weight, more specifically about 0.01 parts by weight to about 0.5 parts by weight based on 100 parts by weight of the monomer mixture including the hydroxyl group-containing (meth)acrylate and the comonomer. Within this range, the adhesive film exhibits improved reliability.

### Additives

The adhesive composition may further include typical additives, such as curing accelerators, ionic liquids, lithium salts, inorganic fillers, softeners, molecular weight regulators, antioxidants, anti-aging agents, stabilizers, adhesion-imparting resins, reforming resins (polyol, phenol, acrylic, polyester, polyolefin, epoxy, epoxidized polybutadiene resins, and the like), leveling agents, defoamers, plasticizers, dyes, pigments (coloring pigments, extender pigments, and the like), treating agents, UV blocking agents, fluorescent whitening agents, dispersants, heat stabilizers, photostabilizers, UV absorbers, antistatic agents, coagulants, lubricants, solvents, and the like.

The adhesive composition may further include a non-curable compound. The adhesive composition does not include a solvent and may have a viscosity at 25° C. of about 300 cPs to about 50,000 cPs. Since the adhesive composition does not include a solvent, the adhesive composition can have improvement in reliability by reducing bubble generation. Within this range, the adhesive composition can have excellent coatability and thickness uniformity.

### Adhesive Film

According to one embodiment of the present invention, an adhesive film may be formed of the adhesive composition as set forth above. The adhesive film may include a hydroxyl group-containing (meth)acrylic copolymer which is polymerized from a monomer mixture including a hydroxyl group-containing (meth)acrylate and a comonomer.

Specifically, the adhesive composition may be prepared by adding an initiator to the monomer mixture to prepare a syrup including a hydroxyl group-containing (meth)acrylic copolymer (prepolymer) through partial polymerization, followed by introducing nanoparticles to the syrup. Alternatively, an initiator is added to a mixture including a hydroxyl group-containing (meth)acrylate, a comonomer (for example, a comonomer having a glass transition temperature (Tg) of about −150° C. to about 0° C.) and nanoparticles, followed by performing partial polymerization, thereby preparing a syrup including a hydroxyl group-containing (meth)acrylic copolymer (prepolymer).

The partially polymerized hydroxyl group-containing (meth)acrylic copolymer may have a weight average molecular weight of about 500,000 g/mol to about 3,000,000 g/mol, specifically about 1,000,000 g/mol to about 2,800,000 g/mol. Within this range, the adhesive film can exhibit improved durability.

The adhesive film may be manufactured by coating the adhesive composition, which is prepared by mixing an initiator and/or a crosslinking agent with the syrup including the partially polymerized hydroxyl group-containing (meth)acrylic copolymer (prepolymer), followed by UV curing.

In one embodiment, the adhesive composition, which is prepared by mixing and partially polymerizing the monomer mixture forming the hydroxyl group-containing (meth)acrylic copolymer, the nanoparticles and a photopolymerization initiator, followed by adding an additional photopolymerization initiator and/or a crosslinking agent to the polymer, is coated onto a release film, followed by curing, thereby manufacturing the adhesive film. Curing may be performed by irradiation at a wavelength of about 300 nm to about 400 nm at a dose of about 400 mJ/cm² to about 30,000 mJ/cm² under oxygen-free conditions using a low-pressure lamp. A coating thickness of the adhesive composition may range from about 10 μm to about 2 mm, specifically from about 20 μm to about 1.5 mm, without being limited thereto.

The adhesive film may be used as an OCA film, or may be formed on an optical film and thus used as an adhesive optical film. Examples of the optical film may include polarizing plates. The polarizing plates include a polarizer and a protective film formed on the polarizer, and may further include a hard coating layer, an anti-reflective layer and the like.

The adhesive film may have a thickness of about 10 μm to about 2 mm, specifically about 50 μm to about 1.5 mm. Within this range, the adhesive film can be used for optical displays.

The adhesive film may have a glass transition temperature (Tg) of about 0° C. or less, specifically about −150° C., −145° C., −140° C., −135° C., −130° C., −125° C., −120° C., −115° C., −110° C., −105° C., −100° C., −95° C., −90° C., −85° C., −80° C., −75° C., −70° C., −65° C., −60° C., −55° C., −50° C., −45° C., −40° C., −35° C., −30° C., −25° C., −20° C., −15° C., −10° C., −5° C., or 0° C. In addition, the adhesive film may have a glass transition temperature (Tg) ranging from about one of the numerical values set forth above to about another one of the numerical values set forth above. For example, the adhesive film may have a glass transition temperature (Tg) of about −150° C. to about 0° C., specifically about −150° C. to about −20° C., more specifically about −150° C. to about −30° C. Within this range, the adhesive film exhibits excellent viscoelasticity at low temperature and room temperature.

The adhesive film may have a storage modulus at 80° C. of about 10 kPa, 20 kPa, 30 kPa, 40 kPa, 50 kPa, 60 kPa, 70 kPa, 80 kPa, 90 kPa, 100 kPa, 150 kPa, 200 kPa, 250 kPa, 300 kPa, 350 kPa, 400 kPa, 450 kPa, 500 kPa, 550 kPa, 600 kPa, 650 kPa, 700 kPa, 750 kPa, 800 kPa, 850 kPa, 900 kPa, 950 kPa, or 1000 kPa. In addition, the adhesive film may have a storage modulus at 80° C. ranging from about one of the numerical values set forth above to about another one of the numerical values set forth above. For example, the adhesive film may have a storage modulus at 80° C. of about 10 kPa to about 1,000 kPa, specifically about 10 kPa to about 300 kPa, more specifically about 10 kPa to about 100 kPa. Within this range, the adhesive film exhibits viscoelasticity even at high temperature as well as excellent recovery rate and is not detached from an adherend even when frequently folded at high temperature, and overflow of the adhesive film can be prevented.

The adhesive film may have a storage modulus at 25° C. of about 10 kPa, 20 kPa, 30 kPa, 40 kPa, 50 kPa, 60 kPa, 70 kPa, 80 kPa, 90 kPa, 100 kPa, 150 kPa, 200 kPa, 250 kPa, 300 kPa, 350 kPa, 400 kPa, 450 kPa, 500 kPa, 550 kPa, 600 kPa, 650 kPa, 700 kPa, 750 kPa, 800 kPa, 850 kPa, 900 kPa, 950 kPa, or 1000 kPa. In addition, the adhesive film may have a storage modulus at 25° C. ranging from about one of the numerical values set forth above to about another one of the numerical values set forth above. For example, the adhesive film may have a storage modulus at 25° C. of about 10 kPa to about 1,000 kPa, specifically about 10 kPa to about 500 kPa, more specifically about 10 kPa to about 300 kPa, still more specifically about 10 kPa to about 150 kPa. Within this range, the adhesive film exhibits viscoelasticity at room temperature and excellent recovery rate.

The adhesive film may have a storage modulus at −20° C. of about 10 kPa, 20 kPa, 30 kPa, 40 kPa, 50 kPa, 60 kPa, 70 kPa, 80 kPa, 90 kPa, 100 kPa, 150 kPa, 200 kPa, 250 kPa, 300 kPa, 350 kPa, 400 kPa, 450 kPa, 500 kPa, 550 kPa, 600 kPa, 650 kPa, 700 kPa, 750 kPa, 800 kPa, 850 kPa, 900 kPa, 950 kPa, or 1000 kPa. In addition, the adhesive film may have a storage modulus at −20° C. ranging from about one of the numerical values set forth above to about another one of the numerical values set forth above. For example, the adhesive film may have a storage modulus at −20° C. of about 10 kPa to about 1,000 kPa, specifically about 10 kPa to about 700 kPa, more specifically about 10 kPa to about 500 kPa, still more specifically about 10 kPa to about 200 kPa. Within this range, since the adhesive film does not suffer from whitening due to flexibility thereof when used for a flexible device at low temperature, the adhesive film can be used for purposes of optical materials.

In addition, a ratio of storage modulus at 80° C. to storage modulus at −20° C. of the adhesive film may range from about 1:1 to about 1:20, specifically from about 1:1 to about 1:15, more specifically from about 1:1 to about 1:10. Within this range, the adhesive film does not suffer from deterioration in adhesion between adherends in a wide temperature range (about −20° C. to about 80° C.) and can be used for flexible optical members.

The adhesive film having a thickness of 100 μm may have a haze of about 4% or less, specifically about 3% or less, more specifically about 2% or less. Within this range, the adhesive film exhibits excellent transparency when used for optical displays.

The adhesive film having a thickness of 100 μm may have a haze of about 5% or less, specifically about 3% or less, more specifically about 2% or less, as measured after the adhesive film is subjected to about 200% stretching. Within this range, the adhesive film exhibits excellent transparency when used for displays.

The adhesive film having a thickness of 100 μm may have a recovery rate of about 30% to about 98%, specifically about 40% to about 95%, more specifically about 40% to about 90%, as calculated by Equation 2. Within this range, the adhesive film can be used for optical displays and has long lifespan.

Recovery rate (%)=(1−(X_{f}/X₀))×100 [Equation 2]

(where X₀ and X_{f} are defined as follows: When both ends of a polyethylene terephthalate (PET) film (thickness: about 75 μm) having a size of about 50 mm×about 20 mm (length×width) are defined as a first end and a second end, respectively, a specimen is prepared by bonding ends of two PET films to each other via an adhesive film having a size of about 20 mm×about 20 mm (length×width) in order of first end of first PET film/adhesive film (length×width: about 20 mm×about 20 mm)/second end of second PET film. Next, jigs are secured to non-bonded ends of the PET films of the specimen, respectively. Next, the jig at one side is kept fixed and the jig at the other side is pulled to a length of about 1,000% of thickness (unit: μm) of the adhesive film (to a length of about 10 times an initial thickness (X₀) of the adhesive film) at a rate of about 300 mm/min and then maintained for about 10 seconds. When a force of about 0 kPa is applied to the adhesive film by recovering the adhesive film at the same rate (about 300 mm/min) as the pulling rate, an increased length of the adhesive film is defined as X_{f} (unit: μm)).

The adhesive film (length×width×thickness: about 13 cm×about 3 cm×about 100 μm) may have a bubble generation area of about 0%, as measured after the adhesive film is subjected to aging at about 70° C. and about 93% RH for about 24 hours. Within this range, the adhesive film does not suffer from detachment from an adherend even at high temperature and high humidity.

The “bubble generation area” refers to a value (%) measured through the following procedures: An adhesive film (length×width×thickness: about 13 cm×about 3 cm×about 100 μm) including a about 50 μm thick PET film stacked on one surface thereof and a about 100 μm thick PET film stacked on the other surface thereof is bent towards the about 50 μm thick PET film such that the length of the adhesive film is halved, and is then placed between parallel frames having a gap of about 1 cm. Next, the adhesive film is subjected to aging at about 70° C. and about 93% RH for about 24 hours, followed by analyzing an image, which is obtained through an optical microscope (EX-51, Olympus Co., Ltd.), using Mac-View software (Mountech Co., Ltd.) to measure a ratio of area occupied by bubbles to area of the adhesive film.

A ratio of length of the adhesive film at break point to length of the adhesive film before stretching may range from about 800% to about 2,000%, specifically about 800% to about 1,800%, more specifically about 900% to about 1,800%, in which the length of the adhesive film at break is measured by stretching the adhesive film at a rate of about 300 mm/min until the adhesive film breaks, after cutting the adhesive film to a size of about 5 cm×about 5 cm×about 100 μm, followed by tightly rolling up the adhesive film and securing both ends of the adhesive film to a TA.XT_Plus texture analyzer (Stable Micro Systems Co., Ltd.). Within this range, the adhesive film maintains viscoelasticity in a wide temperature range and exhibits excellent reliability.

To improve peel strength of the adhesive film, a surface onto which the adhesive composition is coated may be subjected to surface treatment in advance, for example, corona pretreatment at about 150 mJ/cm² or more. Specifically, when the surface onto which the adhesive composition is coated is subjected to corona pretreatment, the adhesive film can exhibit further improved T-peel strength at 25° C. and 60° C. For example, corona pretreatment may be performed by treating a surface of an adherend (for example, a PET film) about twice under corona discharge at a dose of about 78 using a corona treatment device (Now plasma Co., Ltd.), without being limited thereto.

The adhesive film having a thickness of 100 μm may have a T-peel strength of about 400 gf/in, 450 gf/in, 500 gf/in, 550 gf/in, 600 gf/in, 650 gf/in, 700 gf/in, 750 gf/in, 800 gf/in, 850 gf/in, 900 gf/in, 950 gf/in, 1000 gf/in, 1100 gf/in, 1200 gf/in, 1300 gf/in, 1400 gf/in, 1500 gf/in, 1600 gf/in, 1700 gf/in, 1800 gf/in, 1900 gf/in, 2000 gf/in, 2100 gf/in, 2200 gf/in, 2300 gf/in, 2400 gf/in, 2500 gf/in, 2600 gf/in, 2700 gf/in, 2800 gf/in, 2900 gf/in, 3000 gf/in, 3100 gf/in, 3200 gf/in, 3300 gf/in, 3400 gf/in, 3500 gf/in, 3600 gf/in, 3700 gf/in, 3800 gf/in, 3900 gf/in, or 4000 gf/in, as measured at room temperature (25° C.) with respect to a corona-treated PET film. In addition, the adhesive film having a thickness of 100 μm may have a T-peel strength ranging from about one of the numerical values set forth above to about another one of the numerical values set forth above, as measured at room temperature (25° C.) with respect to a corona-treated PET film. For example, the adhesive film having a thickness of 100 μm may have a T-peel strength of about 400 gf/in to about 4,000 gf/in, specifically about 500 gf/in to about 4,000 gf/in, more specifically about 700 gf/in to about 3,500 gf/in, as measured at room temperature (25° C.) with respect to a corona-treated PET film. Within this range, the adhesive film exhibits excellent reliability and adhesion at room temperature.

In addition, the adhesive film having a thickness of 100 μm may have a T-peel strength of about 200 gf/in, 250 gf/in, 300 gf/in, 350 gf/in, 400 gf/in, 450 gf/in, 500 gf/in, 550 gf/in, 600 gf/in, 650 gf/in, 700 gf/in, 750 gf/in, 800 gf/in, 850 gf/in, 900 gf/in, 950 gf/in, 1,000 gf/in, 1100 gf/in, 1200 gf/in, 1300 gf/in, 1400 gf/in, 1500 gf/in, 1600 gf/in, 1700 gf/in, 1800 gf/in, 1900 gf/in, 2000 gf/in, 2100 gf/in, 2200 gf/in, 2300 gf/in, 2400 gf/in, 2500 gf/in, 2600 gf/in, 2700 gf/in, 2800 gf/in, 2900 gf/in, or 3000 gf/in, as measured at 60° C. with respect to a corona-treated PET film. In addition, the adhesive film having a thickness of 100 μm may have a T-peel strength ranging from about one of the numerical values set forth above to about another one of the numerical values set forth above, as measured at 60° C. with respect to a corona-treated PET film. For example, the adhesive film having a thickness of 100 μm may have a T-peel strength of about 200 gf/in to about 3,000 gf/in, specifically about 500 gf/in to about 2,000 gf/in, more specifically about 500 gf/in to about 1,500 gf/in, as measured at 60° C. with respect to a corona-treated PET film. Within this range, the adhesive film exhibits excellent adhesion and reliability even when having a curved shape at high temperature.

The T-peel strength of the adhesive film is measured as follows. A specimen is prepared by laminating corona-pretreated surfaces of PET films having a size of about 150 mm×about 25 mm×about 75 μm (length×width×thickness) to both surfaces of the adhesive film having a size of about 100 mm×about 25 mm×about 100 μm (length×width×thickness). Next, the specimen is subjected to autoclaving under conditions of about 3.5 bar and about 50° C. for about 1,000 seconds and then secured to a TA.XT_Plus texture analyzer (Stable Micro System Co., Ltd.). At 25° C. or 60° C., the PET film at one side is kept fixed and the PET film at the other side is pulled at a rate of about 50 mm/min, thereby measuring T-peel strength of the adhesive film with respect to the PET film. Corona pretreatment of the PET film may be performed, for example, by treating the PET film about twice (total dose: about 156) under corona discharge at a dose of about 78 using a corona treatment device (Now plasma Co., Ltd.), without being limited thereto.

### Display Member

A further aspect of the present invention relates to a display member.

The display member may include an optical film and the aforementioned adhesive film attached to one or both surfaces of the optical film.

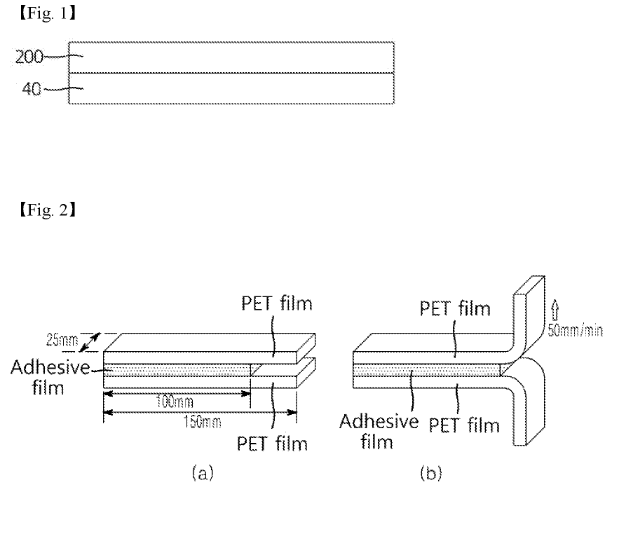

FIG. 1 is a sectional view of a display member according to one embodiment of the present invention.

Referring to FIG. 1, a display member may include an optical film 40 and an adhesive layer or an adhesive film formed on one surface of the optical film 40. Reference numeral 200 in FIG. 1 may represent the adhesive layer or the adhesive film.

In one embodiment, the display member may include the optical film 40 and an adhesive layer 200 formed on one or both surfaces of the optical film 40.

The adhesive layer may be formed of the adhesive composition according to the present invention. Specifically, the adhesive composition, which is prepared by mixing and polymerizing a monomer mixture forming a hydroxyl group-containing (meth)acrylic copolymer, nanoparticles and a photopolymerization initiator, followed by adding an additional photopolymerization initiator to the polymer, may be coated onto the optical film 40, thereby forming the adhesive layer. The method of forming the adhesive layer may further include drying the adhesive layer.

In another embodiment, the display member may include the optical film 40 and the adhesive film 200 according to the present invention, which is formed on one or both surfaces of the optical film 40.

Examples of the optical film may include touch panels, windows, polarizing plates, color filters, retardation films, elliptical polarizing films, reflective films, anti-reflective films, compensation films, brightness improving films, alignment films, optical diffusion films, glass shatter-proof films, surface protective films, OLED device barrier layers, plastic LCD substrates, indium tin oxide (ITO)-containing films, fluorinated tin oxide (FTO)-containing films, aluminum-doped zinc oxide (AZO)-containing films, Ag nanowire-containing films, graphene-containing films, and the like. The optical film can be easily manufactured by those of ordinary skill in the art.

For example, a touch panel may be attached to a window or an optical film via the adhesive film, thereby forming a display member. Alternatively, the adhesive film may be applied to typical polarizing plates as in the art. Specifically, a display may include a capacitive mobile phone as an optical display.

In one embodiment, the display member may be a display member in which a first adhesive film, a touch functional unit, a second adhesive film and a window film are sequentially stacked on an optical device.

The optical device may include an OLED, an LED or a light source, and the first or second adhesive film may be the adhesive film according to the present invention. The touch functional unit may be a touch panel, without being limited thereto.

In addition, the window film may be formed of an optically transparent flexible resin. For example, the window film may include a base layer and a hard coating layer.

The base layer may be formed of at least one of polyester resins such as polyethylene terephthalate, polyethylene naphthalate, polybutylene terephthalate and polybutylene naphthalate; polycarbonate resins; polyimide resins; polystyrene resins; and poly(meth)acrylate resins such as polymethyl methacrylate.

The hard coating layer may have a pencil hardness of about 6H or higher and may be specifically formed of a siloxane resin.

In another embodiment, the display member may include: a liquid crystal panel in which a polarizer is stacked on both surfaces of an LCD cell; a double-sided adhesive tape (DAT) bonding functional films (for example, anti-reflective films) to each other; and a touch panel unit formed on the functional films. The touch panel unit includes: a first adhesive film; a first transparent electrode film stacked on the first adhesive film; a second adhesive film; and a second transparent electrode film. An electrode and an overcoating layer for the electrode are formed on the second transparent electrode film, and a third adhesive film and a window glass are stacked on the overcoating layer in order. An air gap may be removed upon lamination.

Hereinafter, the present invention will be explained in more detail with reference to some examples. It should be understood that these examples are provided for illustration only and are not to be construed in any way as limiting the present invention.

A description of details apparent to those skilled in the art will be omitted for clarity.

### EXAMPLE

(A) Monomer mixture
(a2) 2-ethylhexyl acrylate (EHA) was used.
(a2) 4-hydroxybutyl acrylate (HBA) was used.

(B) Nanoparticles
(b2) 99.5 g of a dimethylsiloxane-diphenylsiloxane crosslinked copolymer, which had an index of refraction of 1.43 and an average particle diameter of 170 nm and included 41% of toluene insolubles, 127.2 g of n-butyl acrylate, and 2.4 g of triallyl isocyanurate were mixed at room temperature, followed by preparing a silicone mixture in which 1.4 g of sodium dodecylbenzenesulfate was dispersed in 760 g of deionized water. 2.4 g of potassium sulfate was introduced to the liquid mixture while the liquid mixture was maintained at 75° C., thereby performing polymerization for 4 hours. Next, 0.7 g of potassium sulfate was additionally introduced to the liquid mixture, followed by performing dropwise addition of a solution, in which 64.8 g of methyl methacrylate and 7.25 g of methyl acrylate were mixed, to the liquid mixture for 15 minutes. Next, the components were reacted at 75° C. for 4 hours and then cooled to room temperature (reaction conversion: 97.4%). The final reaction solution and an aqueous solution of 1.5% MgSO4 were mixed at 75° C., followed by washing and drying, thereby preparing nanoparticles and confirming the presence thereof. The prepared nanoparticles had an index of refraction (NB) of 1.45, an average particle diameter of 173 nm, and a weight ratio of core to shell of 2.36:1.

(b2) 120 g of a dimethylsiloxane-diphenylsiloxane crosslinked copolymer, which had an index of refraction of 1.45 and an average particle diameter of 210 nm and included 60% of toluene insolubles, 127.2 g of 2-ethylhexyl acrylate, and 2.4 g of triallyl isocyanurate were mixed at room temperature, followed by preparing a silicone mixture in which 2.8 g of sodium dodecylbenzenesulfate was dispersed in 980 g of deionized water. 2.4 g of potassium sulfate was introduced to the liquid mixture while the liquid mixture was maintained at 75° C., thereby performing polymerization for 4 hours. Next, 0.7 g of potassium sulfate was additionally introduced to the liquid mixture, followed by performing dropwise addition of a solution, in which 64.8 g of methyl methacrylate and 7.25 g of methyl acrylate were mixed, to the liquid mixture for 15 minutes. Next, the components were reacted for 4 hours and then cooled to room temperature (reaction conversion: 95.8%). The final reaction solution and an aqueous solution of 1.5% MgSO4 were mixed at 75° C., followed by washing and drying, thereby preparing nanoparticles and confirming the presence thereof. The prepared nanoparticles had an index of refraction (NB) of 1.46, an average particle diameter of 214 nm, and a weight ratio of core to shell of 2.79:1.

(C) Radical Photopolymerization Initiator
(c1) Irgacure 651 (2,2-dimethoxy-2-phenylacetophenone, BASF Co., Ltd.) was used.
(c2) Irgacure 184 (1-hydroxycyclohexyl phenyl ketone, BASF Co., Ltd.) was used.
(D) Additive (silane coupling agent): KBM-403 (Shin-Etsu Chemical Co., Ltd.) was used.

### Example 1

2.5 parts by weight of (b1) nanoparticles and 0.005 parts by weight of (c1) a photopolymerization initiator (Irgacure 651) were sufficiently mixed with 100 parts by weight of a monomer mixture, which included 60 wt % of (a1) 2-ethylhexyl acrylate and 40 wt % of (a2) 4-hydroxybutyl acrylate, in a glass container. Dissolved oxygen in the glass container was purged using nitrogen gas, followed by polymerizing the mixture through UV irradiation using a low-pressure lamp (BL lamp, Samkyo Co., Ltd., 50 mW/cm2), thereby obtaining a syrup comprising a partially polymerized a hydroxyl group-containing (meth)acrylic copolymer, nanoparticles and a not-polymerized monomer mixture. 0.35 parts by weight of an additional photopolymerization initiator (Irgacure 184) (c2) was added to the syrup, thereby preparing an adhesive composition. (viscosity: 1500 cPs)

The prepared adhesive composition was coated onto a polyester film (release film, polyethylene terephthalate film, thickness: 50 μm), thereby forming a 100 μm thick adhesive film. An upper side of the adhesive film was covered with a 75 μm thick release film, followed by irradiating both surfaces of the adhesive film with light for 6 minutes using a low-pressure lamp (BL lamp, Samkyo Co., Ltd., 50 mW/cm2), thereby obtaining a transparent adhesive sheet. The adhesive film had a glass transition temperature (Tg) of −38.6° C.

### Examples 2 to 5 and Comparative Example 1

A transparent adhesive sheet was manufactured in the same manner as in Example 1 except that an amount of each of the components in Example 1 was modified as listed in Table 1.

The adhesive films prepared in Examples and Comparative Example were evaluated as to the properties as listed in Table 1. Results are shown in Table 1.

### Evaluation of Properties

(1) Glass transition temperature (Tg, ° C.): A 15 mg (on 6 mm Al Pan) specimen was prepared from each of the adhesive films of Examples and the Comparative Example. The specimen was heated to 100° C. at a heating rate of 20 ° C./min in a nitrogen atmosphere (50 mL/min), followed by cooling to −80° C. at the same rate as the heating rate (first heating condition (1st run)). Next, while the specimen was heated to 100° C. at a heating rate of 10° C./min, a glass transition temperature (Tg) of the specimen was measured.

(2) Storage modulus: Viscoelasticity was measured at a shear rate of 1 rad/sec at a strain of 1% under auto strain conditions using a dynamic viscoelasticity instrument ARES (MCR-501, Anton Paar Co., Ltd.). After removal of a release film, the manufactured adhesive film was stacked to a thickness of 1 mm. Next, the stacked body was subjected to punching using an 8 mm diameter puncher, thereby preparing a specimen. Storage modulus was measured on the specimen at a temperature of −60° C. to 90° C. at a heating rate of 5° C./min, and storage modulus at each of −20° C., 25° C. and 80° C. was recorded.

(3) T-peel strength: A PET film having a size of 150 mm×25 mm×75 μm (length×width×thickness) was subjected to corona treatment twice (total dose: 156) under corona discharge at a dose of 78 using a corona treatment device. An adhesive film sample having a size of 100 mm×25 mm×100 μm (length×width×thickness) was obtained from each of the adhesive sheets of Examples and Comparative Example. Corona-treated surfaces of the PET films were laminated to both surfaces of the adhesive film sample, thereby preparing a specimen as shown in FIG. 2(a). The specimen was subjected to autoclaving at a pressure of 3.5 bar at 50° C. for 1,000 seconds and secured to a TA.XT_Plus texture analyzer (Stable Micro System Co., Ltd.). Referring to FIG. 2(b), the PET film at one side was kept fixed and the PET film at the other side was pulled at a rate of 50 mm/min at 25° C. using a TA.XT_Plus texture analyzer, thereby measuring T-peel strength at 25° C. (see FIG. 2(b)).

In addition, the PET film at one side was kept fixed and the PET film at the other side was pulled at a rate of 50 mm/min at 60° C. using a TA.XT_Plus texture analyzer, thereby measuring T-peel strength at 60° C.

(4) Haze: A haze meter (NDH 5000, Nippon Denshoku Co., Ltd.) was used.

Haze was measured on a specimen having a thickness of 100 μm in accordance with American Society for Testing and Measurement (ASTM) D1003-95 (Standard Test for Haze and Luminous Transmittance of Transparent Plastic).

(5) Haze after 200% stretching: Both ends of a sample (5 cm×5 cm, thickness: 100 μm) of the manufactured adhesive film were secured to both sides of a horizontal tensile tester, followed by removing release films from both surfaces of the sample. After the sample was subjected to 200% stretching in a longitudinal direction (to a length twice an initial length thereof, that is, a length of 10 cm), a glass plate was placed on a lower side of the sample and a release film was placed on an upper side of the sample, followed by bonding the sample to the glass plate through 2 kg rollers, thereby preparing a stretched specimen. Next, the release film was removed from the upper side, followed by measuring haze in the same manner as described above.

(6) Recovery rate: When both ends of each polyethylene terephthalate (PET) film (thickness: 75 μm) having a size of 50 mm×20 mm (length×width) were defined as a first end and a second end, respectively, a specimen was prepared by bonding ends of two PET films to each other via an adhesive film having a size of 20 mm×20 mm (length×width) in order of first end of first PET film/adhesive film/second end of second PET film, and had a contact area of 20 mm×20 mm (length×width) between each of the PET films and the adhesive film (see FIGS. 3(a) and 3(b)). Referring to FIG. 3(a), jigs were secured to non-bonded ends of the PET films of the specimen at room temperature (25° C.), respectively. Next, the jig at one side was kept fixed, and the jig at the other side was pulled to a length of 1,000% of thickness (unit: μm) of the adhesive film (to a length of 10 times an initial thickness (X0) of the adhesive film) at a rate of 300 mm/min and then maintained for 10 seconds. Next, when an increased length of the adhesive film was defined as Xf (unit: μm) when a force of 0 kPa was applied to the adhesive film by recovering the adhesive film at the same rate (300 mm/min) as the pulling rate, recovery rate (%) was calculated by Equation 2:

Recovery rate (%)=(1−(Xf/X0))×100. [Equation 2]

(7) Bubble generation area (%): An adhesive film (length×width×thickness: 13 cm×3 cm×100 μm) including a 50 μm thick PET film stacked on one surface thereof and a 100 μm thick PET film stacked on the other surface thereof was bent towards the 50 μm thick PET film such that the length of the adhesive film was halved, and then placed between parallel frames having a gap of 1 cm. Next, the adhesive film was subjected to aging under conditions of 70° C. and 93% RH for 24 hours, followed by analyzing an image, which was obtained through an optical microscope (EX-51, Olympus Co., Ltd.), using Mac-View software (Mountech Co., Ltd.) to calculate a ratio of area occupied by bubbles to area of the adhesive film.

(8) Index of refraction: Index of refraction was measured using a multi-wavelength Abbe refractometer (DR-M2, ATAGO Co., Ltd.).

TABLE 1

| | | | | | | | Comparative |
|---|---|---|---|---|---|---|---|
| | | Example | | | | | Example |
| | | 1 | 2 | 3 | 4 | 5 | 1 |
| (A) | (a1) | 60 | 60 | 60 | 60 | 60 | 60 |
| | (a2) | 40 | 40 | 40 | 40 | 40 | 40 |
| (B) | (b1) | 2.5 | 5 | 10 | — | — | — |
| | (b2) | — | — | — | 3 | 5 | — |
| (C) | (c1) | 0.005 | 0.005 | 0.005 | 0.005 | 0.005 | 0.005 |
| | (c2) | 0.35 | 0.35 | 0.35 | 0.35 | 0.35 | 0.35 |
| (D) | | 0.1 | 0.1 | 0.1 | — | 0.1 | 0.1 |
| Tg of adhesive film (° C.) | | −36.8 | −37.9 | −39.8 | −36.2 | −37.3 | −38.4 |
| NA | | 1.44 | 1.44 | 1.44 | 1.44 | 1.44 | 1.44 |
| \|NA-NB\| | | 0.01 | 0.01 | 0.01 | 0.02 | 0.02 | — |
| Storage | −20° C. | 129 | 198 | 211 | 185 | 202 | 132 |
| modulus | 25° C. | 42 | 54 | 66 | 45 | 54 | 30 |
| (kPa) | 80° C. | 32 | 44 | 57 | 22 | 27 | 8 |
| T-peel | 25° C. | 584 | 648 | 961 | 672 | 939 | 756 |
| strength | 60° C. | 302 | 385 | 630 | 456 | 626 | 432 |
| (gf/in) | | | | | | | |

| | | | | | | |
|---|---|---|---|---|---|---|
| Haze (%) | 0.95 | 1.01 | 1.12 | 0.98 | 1.05 | 0.87 |
| Haze after 200% | 1.08 | 1.16 | 1.28 | 1.11 | 1.19 | 0.99 |
| stretching (%) | | | | | | |
| Recovery rate (%) | 47.1 | 59.3 | 78.2 | 48.2 | 60.5 | 27.5 |
| Bubble generation area | 0 | 0 | 0 | 0 | 0 | 2.01 |
| (%) | | | | | | |

(In Table 1, NA is an index of refraction of a hydroxyl group-containing (meth)acrylic copolymer; NB is an index of refraction of nanoparticles; and |NA-NB| is a difference in index of refraction between the nanoparticles and the hydroxyl group-containing (meth)acrylic copolymer).

As shown in Table 1, it could be seen that the adhesive films of Examples 1 to 5 maintained viscoelasticity in a wide temperature range, exhibited excellent properties in terms of recovery rate, bubble generation area and adhesion, and had low haze (transparency).

On the other hand, the adhesive film of Comparative Example 1 not including nanoparticles exhibited unsatisfactory results in terms of the properties as set forth above.

Although the present invention has been described with reference to some embodiments, it should be understood that the foregoing embodiments are provided for illustration only and are not to be construed in any way as limiting the invention, and that various modifications, changes, alterations, and equivalent embodiments can be made by those skilled in the art without departing from the spirit and scope of the invention.

1. An adhesive composition comprising:
a monomer mixture comprising a hydroxyl group-containing (meth)acrylate and a comonomer; and
nanoparticles,
wherein the nanoparticles comprise a silicone polymer and have an average particle diameter of about 5 nm to about 800 nm.

2. The adhesive composition according to claim 1, wherein the hydroxyl group-containing (meth)acrylate has a glass transition temperature (Tg) of about −80° C. to about −20° C.

3. The adhesive composition according to claim 1, wherein the comonomer comprises at least one of alkyl (meth)acrylate monomers, ethylene oxide-containing monomers, propylene oxide-containing monomers, amine group-containing monomers, amide group-containing monomers, alkoxy group-containing monomers, phosphoric acid group-containing monomers, sulfonic acid group-containing monomers, phenyl group-containing monomers, and silane group-containing monomers, and has a glass transition temperature (Tg) of about −150° C. to about 0° C.

4. The adhesive composition according to claim 1, wherein the nanoparticles have a core-shell structure in which the core and the shell have a glass transition temperature satisfying Equation 1:
Tg(c)<Tg(s) [Equation 1]
(where Tg (c) is a glass transition temperature (° C.) of the core and Tg (s) is a glass transition temperature (° C.) of the shell).

5. The adhesive composition according to claim 4, wherein the core has a glass transition temperature of about −200° C. to about −40° C. and the shell has a glass transition temperature of about 15° C. to about 200° C.

6. The adhesive composition according to claim 4, wherein the core comprises a polysiloxane and the shell comprises a poly(meth)acrylate.

7. The adhesive composition according to claim 1, wherein the nanoparticles are present in an amount of about 0.1 parts by weight to about 20 parts by weight based on 100 parts by weight of the monomer mixture.

8. The adhesive composition according to claim 1, further comprising: at least one of an initiator and a crosslinking agent.

9. An adhesive film formed of the adhesive composition according to claim 1.

10. The adhesive film according to claim 9, comprising: a hydroxyl group-containing (meth)acrylic copolymer polymerized from a monomer mixture comprising a hydroxyl group-containing (meth)acrylate and a comonomer.

11. The adhesive film according to claim 10, wherein the hydroxyl group-containing (meth)acrylic copolymer is polymerized from the monomer mixture comprising about 15 wt % to about 45 wt % of the hydroxyl group-containing (meth)acrylate and about 55 wt % to about 85 wt % of the comonomer.

12. The adhesive film according to claim 10, further comprising: nanoparticles,
wherein a difference in index of refraction between the nanoparticles and the hydroxyl group-containing (meth)acrylic copolymer is about 0.05 or less.

13. The adhesive film according to claim 9, wherein the adhesive film has a glass transition temperature (Tg) of about 0° C. or less.

14. The adhesive film according to claim 9, wherein the adhesive film has a storage modulus at 80° C. of about 10 kPa to about 1,000 kPa.

15. The adhesive film according to claim 9, wherein the adhesive film has a storage modulus at 25° C. of about 10 kPa to about 1,000 kPa.

16. The adhesive film according to claim 9, wherein the adhesive film has a storage modulus at −20° C. of about 10 kPa to about 1,000 kPa.

17. The adhesive film according to claim 9, wherein a ratio of storage modulus at 80° C. to storage modulus at −20° C. of the adhesive film ranges from about 1:1 to about 1:20.

18. The adhesive film according to claim 9, wherein the adhesive film having a thickness of 100 μm has a haze of about 4% or less.

19. The adhesive film according to claim 9, wherein the adhesive film having a thickness of 100 μm has a haze of about 5% or less, as measured after the adhesive film is subjected to 200% stretching.

20. The adhesive film according to claim 9, wherein the adhesive film having a thickness of 100 μm has a recovery rate of about 30% to about 98%, as calculated by Equation 2:
Recovery rate (%)=(1−(Xf/X0))×100, [Equation 2]
(where X0 and Xf are defined as follows: When both ends of each of polyethylene terephthalate (PET) films (thickness: about 75 μm) having a size of about 50 mm×about 20 mm (length×width) are defined as a first end and a second end, respectively, a specimen is prepared by bonding ends of two PET films to each other via an adhesive film having a size of about 20 mm×about 20 mm (length×width) in order of first end of first PET film/adhesive film (length×width: about 20 mm×about 20 mm)/second end of second PET film. Next, jigs are secured to non-bonded ends of the PET films of the specimen, respectively. Next, the jig at one side is kept fixed and the jig at the other side is pulled to a length of about 1,000% of thickness (unit: μm) of the adhesive film (to a length of about 10 times an initial thickness (X0) of the adhesive film) at a rate of about 300 mm/min and then maintained for about 10 seconds. When a force of about 0 kPa is applied to the adhesive film by recovering the adhesive film at the same rate (about 300 mm/min) as the pulling rate, an increased length of the adhesive film is defined as Xf (unit: μm)).

21. The adhesive film according to claim 9, wherein the adhesive film has a bubble generation area of about 0%, as measured after the adhesive film (length×width×thickness: about 13 cm×about 3 cm×about 100 μm) comprising a about 50 μm thick PET film stacked on one surface thereof and an about 100 μm thick PET film stacked on the other surface thereof is bent towards the about 50 μm thick PET film such that the length of the adhesive film is halved, followed by placing the adhesive film between parallel frames having a gap of about 1 cm, and then subjected to aging under conditions of about 70° C. and about 93% RH for about 24 hours.

22. The adhesive film according to claim 9, wherein the adhesive film has a T-peel strength of about 400 gf/in to about 4,000 gf/in, as measured at 25° C. with respect to a corona-treated polyethylene terephthalate (PET) film.

23. The adhesive film according to claim 9, wherein the adhesive film has a T-peel strength of about 200 gf/in to about 3,000 gf/in, as measured at 60° C. with respect to a corona-treated polyethylene terephthalate (PET) film.

24. A display member comprising:
an optical film; and
the adhesive film according to claim 9, the adhesive film being attached to one or both surfaces of the optical film.

25. The display member according to claim 24, wherein the optical film comprises touch panels, windows, polarizing plates, color filters, retardation films, elliptical polarizing films, reflective polarizing films, anti-reflective films, compensation films, brightness improving films, alignment films, optical diffusion films, glass shatter-proof films, surface protective films, OLED device barrier layers, plastic LCD substrates, indium tin oxide (ITO), fluorinated tin oxide (FTO), aluminum-doped zinc oxide (AZO), carbon nanotube (CNT)-containing films, Ag nanowire-containing films, and graphene-containing films.
